(19) United States
(12) Patent Application Publication
(10) Pub. No.: US 2006/0100396 A1
(43) Pub. Date: May 11, 2006

(54) Softening silicone formulations for textile finishing

(76) Inventors: Winfried Guth, Odenthal (DE); Rainer Idel, Wermelskirchen (DE); Detlev Kierspe, Langenfeld (DE); Friedrich Koch, Koln (DE); Peter Landenberger, Goslar (DE); Helmut-Martin Meier, Ratingen (DE); Horst Lange, Bochum (DE); Roland Wagner, Bonn (DE); Jurgen Krott, Leverkusen (DE); Annette Moller, Leverkusen (DE)

Correspondence Address: LANXESS CORPORATION, 111 RIDC PARK WEST DRIVE, PITTSBURGH, PA, 15275-1112, US

(21) Appl. No.: 10/514,931

(22) PCT Filed: May 13, 2003
(86) PCT No.: PCT/EP03/04965

§ 371 Date: Sep. 2, 2005

(30) Foreign Application Priority Data
May 14, 2002 (DE) 102 21 531.9

(51) Int. Cl. C08L 83/08; D06M 13/513; B32B 27/04

(52) U.S. Cl. 525/474; 252/8.81

(57) ABSTRACT

The invention concerns novel formulations containing at least one quaternized aminoalkylsiloxane and at least one compound selected among: a) non-ionic hydrophilic surfactant compounds, b) hydrophilic dispersants and c) divalent of trivalent metal salts with inorganic acids. Said formulations are excellent textile softeners for finishing textile structures in accordance with continuous or drawing process and are characterized by particular shearing stability.

The invention relates to novel formulations based on quaternized aminoalkylsilicones or -siloxanes, to processes for preparing these formulations and to their use as textile assistants for finishing textile materials.

Silicone softeners are used widely for the finishing of textile materials. For the practical use of the silicone softener emulsions, requirements such as storage stability, thermal stability, resistance toward whiteners and other anionic textile assistants, resistance to pH changes and salt addition and against the action of mechanical energy are of central significance. Particularly the stability against the action of mechanical energy, the shear stability or jet stability, often presents silicone softener emulsions with great difficulties under industrial conditions (cf. R. Zyschka, Melliand Textilberichte June 2001, 497).

Microemulsions offer the fundamental advantage of thermodynamic stability. In a multitude of publications, the equilibrium phase behavior is treated as a function of the structure of the oil to be emulsified and/or of the surfactant(s). Likewise systematically studied has been the addition of inorganic salts (cf. M. Kahlweit et al., Langmuir 11[1995], 3382; M. Kahlweit et al., Langmuir 11[1995]). The equilibrium phase behavior of microemulsions of low molecular weight silicones has likewise been investigated (EP-A 774482; H. von Berlepsch et al, Progr. Colloid Polymer Science 111[1998], 107).

With regard to the softening components, combinations of hydrocarbon-based quats with silicone quats (GB-A 1549180) or else silicone polyethers with silicone quats (U.S. Pat. No. 4,921,895) have been proposed.

To improve the hydrophilicity, the widely utilized aminoalkylsiloxanes are increasingly being replaced by polyether-modified aminoalkylsiloxane oils (cf. EP-A 578144).

An additional introduction of alkoxysilyl structures into polyether- and amino-substituted silicones has likewise been proposed (US-A 20020028900).

Finally, true permanently hydrophilic textile softeners based on silicone quats have been disclosed in WO 02/10256, WO 02/10257 and WO 02/10259.

Fine microemulsions of aminoalkylsiloxanes are said to be obtainable in a two-stage process by preparing a concentrate of aminoalkylsiloxane, silicone-insoluble surfactant and a little water with subsequent rapid stirring into water (U.S. Pat. No. 4,620,878).

According to DE-A 3723697, aminosiloxane emulsions are said to become mechanically stable as a result of the use of water-soluble nonionogenic emulsifiers. For extreme shear stresses, as are achieved on modern jet plants, it has been found that the inventions disclosed in DE-A 3723697 are insufficient to prevent deposits in the jet plant and on the textiles to be treated.

According to WO 02/10501, aminofunctional organosilicon compounds are said to become mechanically stable even in jet dyeing machines without using water-soluble nonionogenic emulsifiers. It has been found that the inventions disclosed in WO 02/10501 are likewise not yet sufficient to reliably prevent deposits on differently pretreated textiles.

Mechanical stability of aminosiloxane microemulsions is also said to be achievable by using betaines, optionally in combination with nonionogenic surfactants of the HLB range from 5 to 16 (cf. U.S. Pat. No. 5,573,694; U.S. Pat. No. 5,520,827).

It is known in dyeing technology that complex mixtures which comprise sulfonated alkylnaphthyl derivatives and halogenated hydrocarbons can be utilized as jet-stable dyeing accelerator formulations (U.S. Pat. No. 4,080,166).

Such sulfonated naphthyl derivatives in combination with fatty alcohol ethoxylates have also been proposed for the stabilization of inkjetable formulations (U.S. Pat. No. 6,302,948). The combination of fatty alcohol ethoxylates with pigments of a certain size is likewise said to lead to inkjetable systems (U.S. Pat. No. 6,099,627).

Finally, it is also known that salts of strong acids, e.g. Al₂(SO4)₃×18 H₂O ensure protonation of cationic dyes in thermal transfer printing pastes but simultaneously impair their stability (cf. U.S. Pat. No. 5,925,701).

It is common to all of the proposals cited that they do not contain any hints to measures by which emulsions or microemulsions of silicone-based textile softeners, preferably aminosiloxanes and quaternized aminoalkylsiloxanes (silicone quats) can be stabilized reliably against the action of high mechanical energy input of the modern jet systems in combination with greatly varying liquor ratios and the influence of varying pretreatment preparations on the fibers. Moreover, the prior art does not disclose any measures by which the simultaneously occurring high foaming tendency (causes stain formation) of textile softener formulations under high mechanical energy input can be restricted.

It is thus an object of the present invention to describe measures by which emulsions or microemulsions of silicon-based textile softeners, preferably quaternized aminoalkylsiloxanes (silicone quats), can be reliably stabilized under the action of high energy input (extremely high shear forces in modern jet systems) in combination with greatly varying liquor ratios, and the influence of varying pretreatment preparations and the foaming tendency can be simultaneously restricted.

It has been found that, surprisingly, this object is achieved by the combination of quaternized aminoalkylsiloxanes with highly hydrophilic nonionogenic interface-active compounds (surfactants) and/or highly hydrophilic dispersants and/or salts of polyvalent cations and optionally further customary formulation agents.

The present invention therefore relates to formulations comprising at least one quaternized aminoalkylsiloxane and at least one compound from the group of
a) the hydrophilic, nonionogenic, interface-active compounds,
b) the hydrophilic dispersants and
c) the salts of di- or trivalent metals with inorganic acids.

Preferred hydrophilic, nonionogenic, interface-active compounds (a) in the context of the invention are substances which lower the surface tension of water to below 45 mN/m. They are in particular compounds modified with ethylene/propylene oxide (EO/PO), optionally unsaturated and/or branched, from the group of the fatty alcohols, fatty acids, alcohols, acids, alkylaryl derivatives, fatty amines, glycerides and sorbitan esters, in each of which the number of EO/PO units is between 15 and 150, the ratio of PO units to EO units being equal to 0.25 or lower than 0.25, and in each of which the number of ethylene oxide units (EO fraction) is greater than or equal to the number of carbon atoms in the non-EO fraction, or are alkyl-polyglycosides, ethylene oxide/propylene oxide copolymers and polyethersiloxanes.

Hydrophilic dispersants (b) in the context of the invention are substances which, when added to water, lower the surface tension to a value between 72 to 45 mN/m.

The preferred compounds (b) are water-soluble polysaccharides such as carboxy-methylcellulose, hydroxyethylcellulose, methylhydroxypropylcellulose or compounds of the formula 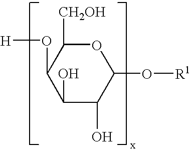
where
x is from 1.5 to 20, preferably from 1.5 to 10.

The salts (c) are metal salts having a valency of two or higher, preferably calcium, magnesium and aluminum salts, optionally in the form of their hydrates, with inorganic acids such as hydrochloric acid, sulfuric acid, phosphoric acid. The counterions are to be selected in such a way that sufficient water and formulation solubility is ensured at a given stability of the salt. Examples of such salts are Ca(Cl)₂, Mg(Cl)₂ and Al₂(SO₄)₃, optionally in the form of their hydrates. Specifically, the compounds (a) are those of the formulae 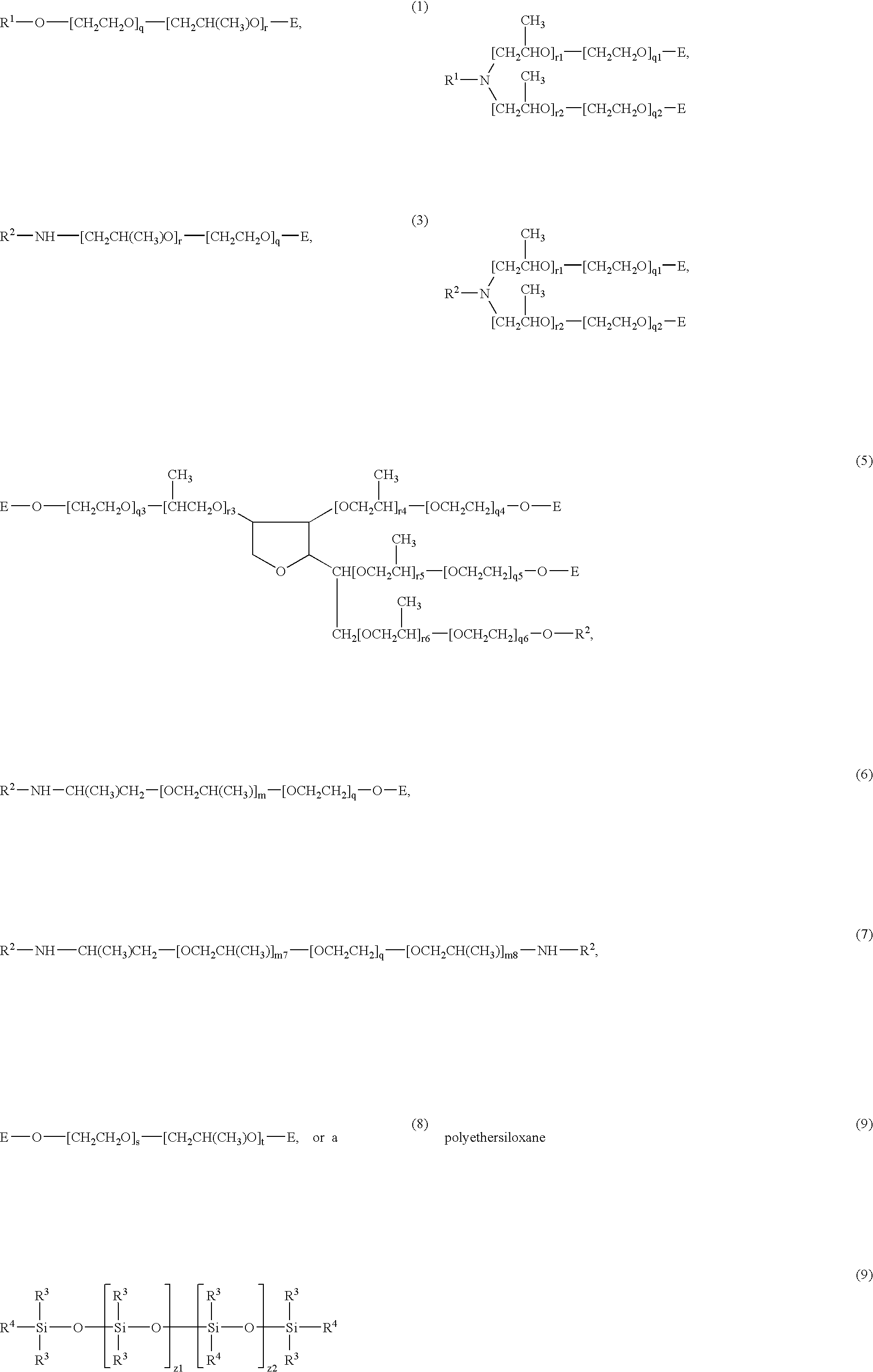
where
E is an R¹ radical, hydrogen, straight-chain or branched, saturated or mono- or polyunsaturated C₁-C₁₈-alkyl which is optionally mono- or polysubstituted by —OH, C₁-C₄-alkoxy, C₁-C₄-alkoxycarbonyl or carbonyl, or is C₅-C₁₀-cyclo-alkyl which is optionally mono- or polysubstituted by C₁-C₄-alkyl, —OH, C₁-C₄-alkoxy, C₁-C₄-alkoxycarbonyl or carbonyl
R¹ is straight-chain or branched, saturated or unsaturated C₈-C₄₀-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₁₀-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, C₁-C₄-alkoxycarbonyl or carbonyl, amino, mono- or di-C₁-C₄-alkylamino,
R² is straight-chain or branched, saturated or mono- to polyunsaturated C₈-C₄₀-alkyl which is optionally mono- or polysubstituted by —OH, C₁-C₄-alkoxy, C₁-C₄-alkoxycarbonyl or carbonyl,
R³ is straight-chain or branched C₁-C₂₆-alkyl or C₆-C₁₀-aryl,
   —CH₂CH₂—O—[CH₂CH₂O]_{q}—[CH₂CH(CH₃)O]ᵣ-E,
   —CH₂CH₂CH₂—O—[CH₂CH₂O]_{q}—[CH₂CH(CH₃)O]ᵣ-E
   —CH₂CH₂CH₂—O—CH₂CHOHCH₂—O—[CH₂CH₂O]_{q}—[CH₂CH(CH₃)O]ᵣ-E
   —Z—[CH₂CH₂O]_{q}—[CH₂CH(CH₃)O]ᵣ-E
   where
   Z is a straight-chain or branched alkyl or cycloalkyl radical which is in each case interrupted by —O— and/or —CO— and may optionally be substituted by at least one OH group,
   or 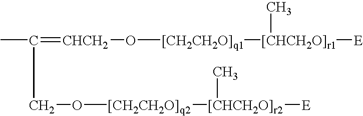
   q is from 15 to 150,
   q1 and q2 are each independently from 0 to 150,
   where the sum of q1+q2=q,
   q3, q4, q5 and q6 are each independently from 0 to 150
   where the sum of q3+q4+q5+q6=q,
   r is from 0 to 50,
   r1 and r2 are each independently from 0 to 50
   where the sum of r1+r2=r,
   r3, r4, r5 and r6 are each independently from 0 to 50
   where the sum of r3+r4+r5+r6=r, and
   the ratio of r:q≦0.25,
   m is from 1 to 50,
   m7 and m8 are each independently from 1 to 50
   where 2≦m7+m8 and the sum of m7+m8=m+1, and
   the ratio of q:m ≧4,
   s is from 5 to 150,
   t is from 5 to 150
   where 0.05≦s:t≦20,
   0≦z1≦2000,
   at least one R4≠R3, and
   0.01≦Σ alkyl radicals R³:Σ q+r≦1.

Specifically, the compounds (a) are also those of the formulae (1′) to (9′) 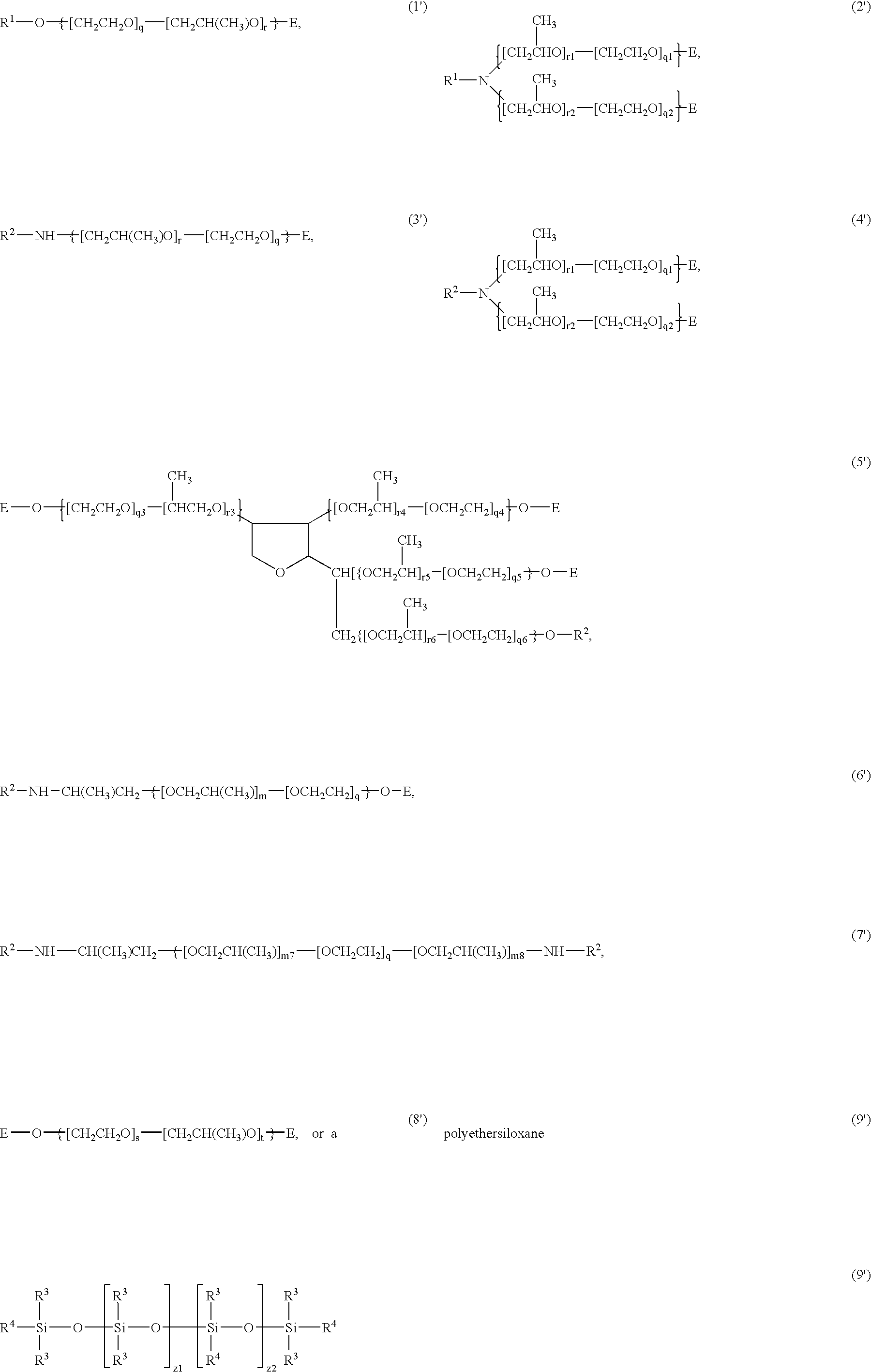
where
the brackets “{” and “}” shown in formulae (1′)-(8′) mean that the ethylene oxide or propylene oxide units within these brackets may either be arranged blockwise as shown or else be in any random distribution,
E is an R¹ radical, hydrogen, straight-chain or branched, saturated or mono- or polyunsaturated C₁-C₁₈-alkyl which is optionally mono- or polysubstituted by —OH, C₁-C₄-alkoxy, C₁-C₄-alkoxycarbonyl or carbonyl, or is C₅-C₁₀-cyclo-alkyl which is optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₈-C₄₀-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₁₀-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, C₁-C₄-alkoxycarbonyl or carbonyl, amino, mono- or di-C₁-C₄-alkylamino, or is C₆-C₁₀-aryl which is optionally substituted, especially by C₃-C₁₅-alkyl,
R² is straight-chain or branched, saturated or mono- to polyunsaturated C₈-C₄₀-alkyl which is optionally mono- or polysubstituted by —OH, C₁-C₄-alkoxy, C₁-C₄-alkoxycarbonyl or carbonyl,
R³ is straight-chain or branched C₁-C₂₆-alkyl or C₆-C₁₀-aryl,
R⁴ is R³ or is a radical of the formulae 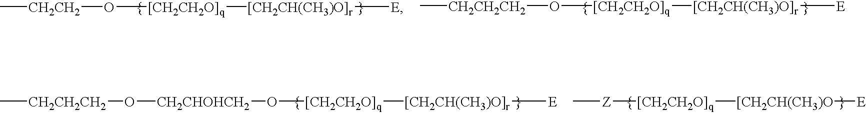
   where
   Z is a straight-chain or branched alkyl or cycloalkyl radical which is in each case interrupted by —O— and /or —CO— and may optionally be substituted by at least one OH group
   or 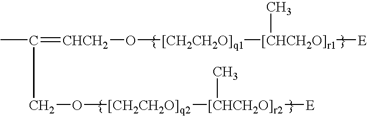
   where the brackets “{” and “}” shown in the aforementioned formulae again mean that the ethylene oxide or propylene oxide units within these brackets may either be arranged blockwise as shown or else may be in any random distribution,
   q is from 15 to 150,
   q1 and q2 are each independently from 0 to 150
   where the sum of q1+q2=q,
   q3, q4, q5 and q6 are each independently from 0 to 150
   where the sum of q3+q4+q5+q6=q,
   r is from 0 to 50,
   r1 and r2 are each independently from 0 to 50
   where the sum of r1+r2=r,
   where the sum of r3+r4+r5+r6=r, and
   the ratio of r:q≦0.25,
   m is from 1 to 50,
   m7 and m8 are each independently from 1 to 50
   where 2≦m7+m8 and
   the ratio of q:m≧4,
   s is from 5 to 150, preferably 15-150,
   t is from 5 to 150, preferably from 5 to 150 and in particular from 5 to 20,
   where t:s≦0.25
   0≦z1≦2000,
   0≦z2≦2000,
   at least one R4≠R3, and
   for formula (9′):
      0.01≦Σ alkyl radicals R³:Σ q+r≦1.

In particular, the compounds (a) are those of the formulae (1) to (9) where
E is hydrogen, straight-chain or branched, saturated or mono- or polyunsaturated C₁-C₄-alkyl which is optionally mono- to disubstituted by —OH, C₁-C₄-alkoxy, C₁-C₄-alkoxycarbonyl or carbonyl, or is C₅-C₆ -cycloalkyl which is in each case optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₁₀-C₃₆-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₆-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, C₁-C₄-alkoxycarbonyl or carbonyl, amino, mono- or di-C₁-C₄-alkylamino,
R² is straight-chain or branched, saturated or mono- to polyunsaturated C₁₀-C₃₆-alkyl which is optionally mono- or polysubstituted by —OH, C₁-C₄-alkoxy, C₁-C₄-alkoxycarbonyl or carbonyl,
R³ is straight-chain or branched C₁-C₁₈-alkyl or C₆-C₁₀-aryl,
R⁴ is an R³ radical or is a radical of the formulae
   or
      —CH₂CH₂CH₂—O—[CH₂CH₂O]_{q}—[CH₂CH(CH₃)O]ᵣ-E,
   q is from 20 to 100,
   q1 and q2 are each independently from 20 to 100
   where the sum of q1+q2=q,
   q3, q4, q5 and q6 are each independently from 20 to 100
   where the sum of q3+q4+q5+q6=q,
   r is from 0 to 20,
   r1 and r2 are each independently from 0 to 20
   where the sum of r1+r2=r,
   r3, r4, r5 and r6 are each independently from 0 to 20
   where the sum of r3+r4+r5+r6=r, and
   the ratio of r:q≦0.25,
   m is from 1 to 7,
   m7 and m8 are each independently from 1 to 7
   where 2≦m7+m8 and the sum of m7+m8=m+1, and
   the ratio of q:m≧4,
   s is from 5 to 100,
   t is from 5 to 100
   where0.05≦s:t≦20,
   0≦z1≦2000,
   0≦z2≦2000,
   at least one R4≠R3, and
   and
   0.01≦Σ alkyl radicals R³:Σ q+r≦0.5.

In particular, the compounds (a) are those of the formulae (1′) to (9′) where
E is hydrogen, straight-chain or branched, saturated or mono- or polyunsaturated C₁-C₄-alkyl which is optionally mono- to disubstituted by —OH, C₁-C₄-alkoxy, C₁-C₄-alkoxycarbonyl or carbonyl, or is C₅-C₆ -cycloalkyl which is in each case optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₁₀-C₃₆-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₆-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, C₁-C₄-alkoxycarbonyl or carbonyl, amino, mono- or di-C₁-C₄-alkylamino, or is C₆-C₁₀-aryl which is optionally substituted, especially by C₃-C₁₅-alkyl,
R² is straight-chain or branched, saturated or mono- to polyunsaturated C₁₀-C₃₆-alkyl which is optionally mono- or polysubstituted by —OH, C₁-C₄-alkoxy, C₁-C₄-alkoxycarbonyl or carbonyl,
R³ is straight-chain or branched C₁-C₁₈-alkyl or C₆-C₁₀-aryl,
R⁴ is an R³ radical or is a radical of the formulae 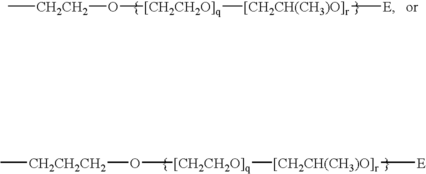
   q is from 20 to 100,
   q1 and q2 are each independently from 20 to 100
   where the sum of q1+q2=q,
   q3, q4, q5 and q6 are each independently from 20 to 100
   where the sum of q3+q4+q5+q6=q,
   r is from 0to 20,
   r1 and r2 are each independently from 0 to 20
   where the sum of r1+r2=r,
   r3, r4, r5 and r6 are each independently from 0 to 20
   where the sum of r3+r4+r5+r6=r, and
   the ratio of r:q≦0.25,
   m is from 1 to 7,
   m7 and m8 are each independently from 1 to 7
   where 2≦m7+m8 and
   the ratio of q:m≧4,
   s is from 5 to 100, preferably from 15 to 100
   t is from 5 to 100, preferably from 5 to 20
   where t:s≦0.25,
   0≦z1≦2000,
   0≦z2≦2000,
   at least one R4≠R3,
   and
for the formula (9′):
   0.01≦Σ alkyl radicals R³:Σ q≦0.5.

The compounds (a) are more preferably those of the formulae (1) to (9) where
E is H—, CH₃—, CH₃CH₂—, CH₃CH₂CH₂—, (CH₃)₂CH—, CH₃CH₂CH₂CH₂— or CH₃C(O)—
R¹ is a radical of the formulae 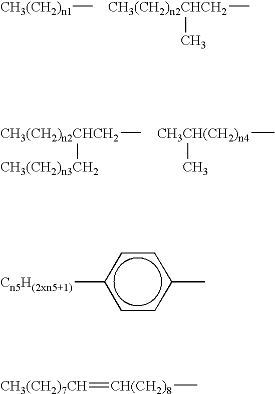
   where
   n1=from 9 to 23,
   n2=from 3 to 23,
   n3=from 0 to 18,
   n4=from 7 to 23,
   n5=from 3 to 15,
R² is a radical of the formulae 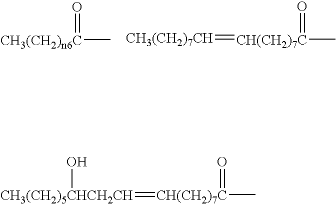
   where
   n6=8to to 28,
R³ is C₁-C₁₈-alkyl or C₆-C₁₀-aryl,
R⁴ is an R³ radical or is a radical of the formulae
   —CH₂CH₂—O—[CH₂CH₂O]_{q}—[CH₂CH(CH₃)O]ᵣ-E,
   or
      —CH₂CH₂CH₂—O—[CH₂CH₂O]_{q}—[CH₂CH(CH₃)O]ᵣ-E
   q is from 25 to 60,
   q1 and q2 are each independently from 25 to 60
   q3, q4, q5 and q6 are each independently from 25 to 60
   where the sum of q3+q4+q5+q6=q,
   r is from 0 to 10,
   r1 and r2 are each independently from 0 to 10
   where the sum of r1+r2=r,
   r3, r4, r5 and r6 are each independently from 0 to 10,
   where the sum of r3+r4+r5+r6=r, and
   the ratio of r:q≦0.25, and
   0.01≦Σ alkyl radicals R³:Σ q+r <0.1.

The compounds (a) are more preferably also those of the formulae (1′) to (9′) where
E is H—, CH₃—, CH₃CH₂—, CH₃CH₂CH₂—, (CH₃)₂CH—, CH₃CH₂CH₂CH₂— or CH₃C(O)—
R¹ is a radical of the formulae 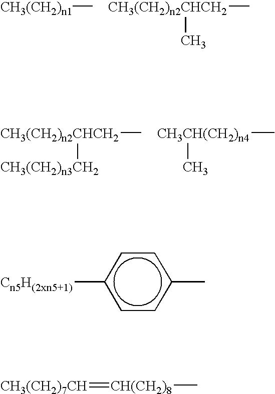
   where
   n1=from 9 to 23,
   n2=from 3 to 23, preferably from 6 to 23
   n3=from 0 to 18, where, preferably, n2+n3≦31,
   n4=from 7 to 23,
   n5=from 3 to to 15,
R² is a radical of the formulae 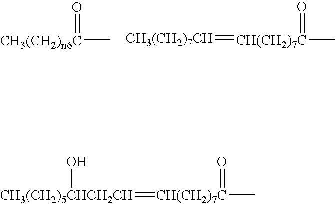
   where
   n6=8to to 28,
R³ is C₁-C₁₈-alkyl or C₆-C₁₀-aryl,
R⁴ is an R³ radical or is a radical of the formulae 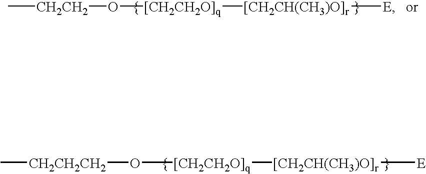
   q is from 25 to 60,
   q1 and q2 are each independently from 25 to 60
   q3, q4, q5 and q6 are each independently from 25 to 60
   where the sum of q3+q4+q5+q6=q,
   r is from 0 to 10,
   r1 and r2 are each independently from 0 to 10
   where the sum of r1+r2=r,
   r3, r4, r5 and r6 are each independently from 0 to 10
   where the sum of r3+r4+r5+r6=r, and
   the ratio of r:q≦0.25, and
   for the formula (9′):
      0.01≦Σ alkyl radicals R³:Σ q≦0.1.

Very particular preference is given to inventive formulations which comprise, as compound (a), the ester of stearic acid and 40 mol of EO.

The inventive formulations comprise at least one aminoalkylsiloxane compound quaternized on the nitrogen (silicone quat). Such compounds and their preparation are known, for example, from WO 02/10 256, WO 02/10 257, WO 02/10 259, EP 282 720, EP 17 121, DE-A 100 36 533, DE-A 100 36 539, DE-A 100 36 532, DE-A 100 36 522 and DE -A 102 12 470.

The quaternized aminoalkylsiloxane compounds present in the inventive formulations preferably correspond to linear or cyclic polysiloxane polymers of WO 02-10259 having repeating essential structural units of the formulae (10) and (11) 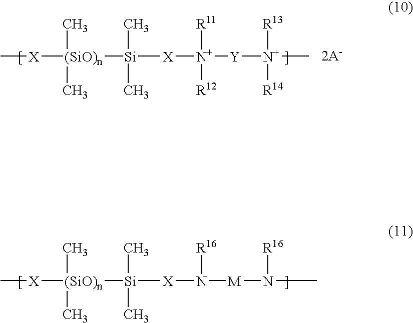
where
X is a divalent hydrocarbon radical having at least 4 carbon atoms which may have a hydroxyl group, preferably has a hydroxyl group, and which may be interrupted by one oxygen atom, and the X groups in the repeating units may be the same or different,
Y is a divalent hydrocarbon radical having at least 2 carbon atoms which has a hydroxyl group and which may be interrupted by one or more oxygen or nitrogen atoms,
R¹¹, R¹², R¹³ and R¹⁴ are the same or different and are each alkyl radicals having from 1 to 4 carbon atoms or benzyl radicals, or the R¹¹ and R¹³ or R¹² and R¹⁴ radicals may in each case be constituents of a bridging alkylene radical,
R¹⁶ is H or an alkyl radical having from 1 to 20 carbon atoms which may be oxygen-substituted,
M is the structure —B—O-(EOx)ᵥ(POx)_{w}-B—, where
   EOx is an ethylene oxide unit and POx is a propylene oxide unit,
B is straight-chain or branched C₂-C₆-alkylene,
v is from 0 to 200,
w is from 0 to 200,
   v+w≧1,
n is from 2 to 1000 where the n in the repeating units may be the same or different,
A- is an inorganic or organic anion.

The inventive formulations in some cases also comprise any mixtures of the above-designated quaternized aminoalkylsiloxane compounds with the corresponding nonquaternized compounds. In these nonquaternized compounds, in each case one of the R¹¹ or R¹² radicals or R¹³or R¹⁴ radicals in the main chain on the nitrogen atoms in the formula (10) is thus absent.

The quaternized aminoalkylsiloxane compounds which are preferred in accordance with the invention form part of the subject-matter of WO 02/10 259 and are described there generally and specifically. The contents of WO 02/10 259 are incorporated fully by the present application.

In a preferred embodiment of the invention, the amounts of hydrophilic, nonionogenic, interface-active compounds (a) and/or hydrophilic dispersants (b) and/or salts (c) to the amounts of quaternized aminoalkylsiloxane compounds are in a weight ratio Ω of Ω=0.05 to 10, preferably Ω=0.05 to 5, especially Q =0.05 to 3, very especially Ω=0.05 to 1. Ω illustrates only the ratio of total amount of component (a) to (c) to amount of silicone quat. When the amounts of additive (a) and/or (b) and/or (c) are too small, the effective stabilization in the fiber finishing is exhausted, i.e., for example, that the shear stability under some circumstances cannot always be maintained under strong mechanical shear, high temperatures, long finishing cycles. Very large additive amounts are uneconomic and can change the hand of the textile in an undesired manner.

The additives a) to c) described may be added in two ways. It is possible firstly to introduce the inventive additives directly into the formulations. Secondly, it may be favorable under practice conditions to first dilute the formulations to use concentration and to subsequently add the inventive additives to the liquor prepared.

In addition to components (a) and/or (b) and/or (c), the inventive formulations may also comprise further interface-active components (f) which enable emulsification or microemulsification.

These components (f) are customary formulation agents, known to those skilled in the art, for preparing the silicone (micro)emulsions which, however, alone are not stable against high energy input. Such preferred components f1) to f6) include: (f1) oxalkylation products which are obtainable by alkoxylating, with ethylene oxide or propylene oxide, condensation products of phenolic OH-containing aromatics with formaldehyde and NH functional groups. f2) nonionic or ionically modified compounds from the group of the alkoxylates, alkylolamides, esters, amine oxides and alkylpolyglycosides, especially reaction products of alkylene oxides with alkylatable compounds, for example fatty alcohols, fatty amines, fatty acids, phenols, alkylphenols, carboxamides and resin acids. They are, for example, ethylene oxide ethers from the class of the reaction products of ethylene oxide with saturated and/or unsaturated fatty alcohols having from 6 to 25 carbon atoms (commercially available, for example, in the form of Renex® product series) or alkylphenols having from 4 to 12 carbon atoms in the alkyl radical or saturated and/or unsaturated fatty amines having from 14 to 20 carbon atoms or saturated and/or unsaturated fatty acids having from 14 to 22 carbon atoms, or esterification and/or arylation products which are prepared from natural or modified, optionally hydrogenated castor oil fatty substances and are optionally joined to give repeating units by esterification with dicarboxylic acids. f3) ionic or nonionic compounds from the group of the reaction products of alkylene oxide with sorbitan esters [Tween, ICI], oxalkylated acety-lenediols and glycols, oxalkylated phenols, especially phenol/styrene polyglycol ethers. f4) ionic or nonionic polymeric surface-active agents from the group of the homo- and copolymers, graft polymers and graft copolymers and random and linear block copolymers. f5) anionic surface-active agents, for example alkyl sulfates, ether sulfates, ether carboxylates, phosphate esters, sulfosuccinamides, paraffin sulfonates, olefin sulfonates, sarcosinates, isothionates and taurates. f6) amphoteric surface-active agents such as betaines and ampholytes especially glycinates, propionates and imidazolines.

Particularly preferred formulation constituents (f) are alkoxylated fatty alcohols, branched fatty alcohols and fatty acids having from 4 to 14 alkoxy units; very particularly preferred formulation constituents (f) are alkoxylated fatty alcohols, branched fatty alcohols having from 6 to 12 alkoxyl units, especially formulations which contain the ether of tridecyl alcohol with 12 mol of EO, the ether of tridecyl alcohol with 6 mol of EO.

The formulation constituents are generally added in customary amounts to the inventive formulation. Preference is given to adding the components (f) in amounts of from 1 to 200% by weight, preferably from 10 to 80% by weight, more preferably 10-50% by weight, based on the quaternized aminoalkylsiloxane.

In addition to component(s) (a) to (c), the formulations, in each case alone or in combination, and the additives (f) may also comprise further assistants in the amounts customary for these assistants.

Typical assistants in the context of the invention include leveling agents, wetting agents, lustering agents, fiber protection agents, antislip agents and further prior art assistants. A good overview of the inventive assistants can be found in Chwala/Anger, Handbuch der Textilhilfsmittel, Verlag Chemie, Weinhein 1977.

Furthermore, buffer systems may be used to obtain an optimal pH value during the finishing.

To prepare the inventive formulations, the quaternized aminoalkylsiloxane compounds may be mixed with components (a), (b) and/or (c), optionally with addition of further, abovementioned constituents, preferably within a temperature range of from 20 to 90° C., more preferably of from 25 to 70° C., most preferably from 30 to 60° C.

The quaternized aminoalkylsiloxanes are preferably added to the compound(s) (a), (b) and/or (c), particular preference is given to initially charging the quaternized aminoalkylsiloxane (silicone quat) and completing the emulsion formulation by adding the compound(s) (a), (b) and/or (c) and optionally further additives.

The inventive formulations are outstandingly suitable as textile softeners in the finishing of textile structures, especially those made of cotton, keratin fibers, preferably wool, silk or synthetic fibers or, for example, used very efficiently for the finishing of textile structures made of mixtures of cotton with polyester, polyamide, polyacrylonitrile, wool or silk. Excellent results are equally achieved in the finishing of textile structures made of synthetic fibers, especially made of polyester, polyamide, polypropylene or mixtures thereof.

Textile structures are preferably wovens, knits, including formed-loop knits, and nonwovens.

It has been found that the inventive formulations are particularly advantageous for the finishing of cotton or cotton-containing textiles which have been pretreated with anionic lighteners by the jet process.

When the inventive formulations are used, it is possible not only to achieve outstanding softener results but also an improvement in other properties of the textile such as the solubility or an increase in the gloss.

The finishing is generally effected by the continuous process (pad mangle or backwasher process) or by the exhaustion process (jet process). When the inventive formulations are employed by one of these finishing processes, it has been found to be advantageous to maintain the following technological parameters:

Continuous (for Example Pad Mangle, Backwasher)

1. At 11% silicone concentration: 5-50 g/l, preferably 10-40 g/l and especially 10-25 g/l of SQ (=silicone quat) formulation+a) to c)

2. Finishing temperature: Room temperature

3. Drying temperature: 75-105° C. in a forced-air drying cabinet or 10-60 sec on a tenter frame at 150° C., particularly 30-45 sec

4. Time in the forced-air drying cabinet: 10-20 minutes

Exhaustion Process (for Example Jet, Winchbeck)

1. At 11% silicone concentration: 1.0-5.0%, preferably 1.5-3.5% and especially 1.5-2.5%

2. Finishing temperature: 30-60° C., preferably 35-50° C. and especially 35-45° C.

3. Heating rate: 2-4° C./minute

4. Finishing time: 15-25 minutes

5. Liquor ratio: from 1:5 to 1:50, particularly from 1:10 to 1:30

6. Drying temperature 75-105° C. in a forced-air drying cabinet or 10-60 sec on a tenter frame at 150° C., particularly 30-45 sec

7. Time in the forced-air drying cabinet:10-20 minutes

### EXAMPLES

In the formulations which follow, a silicone quat (SQ) synthesized according to WO 02/10259, Example 1, was used which had the following structural elements and is prepared as follows:

1a) A 1 liter three-neck flask was initially charged at room temperature with 24 g of water and 4.18 g (0.048 mol of tertiary amino groups) of N,N,N′,N′-tetramethyl-1,6-hexanediamine and 3.8 g (0.012 mol of primary amino groups) of an alkylene oxide derivative, obtainable under the trade name Jeffamin® ED 600, of the structure
H₂NCH(CH₃)CH₂[OCH₂CH(CH₃)]ₐ(OCH₂CH₂)₉ [OCH₂CH(CH₃)]_{b}NH₂

where a+b=3.6.

Within 5 minutes, 12.0 g (0.03 mol) of dodecanoic acid in the form of a 50% solution in 2-propanol and 1.8 g (0.03 mol) of acetic acid were added. After the mixture had been heated to 50° C., 194.1 g (0.06 mol of epoxy groups) of an epoxy siloxane of the average composition

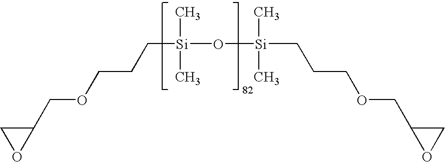

and 30 ml of 2-propanol were added dropwise within 30 minutes. The yellow, opaque mixture was heated to reflux temperature for 6 hours. After removal of all constituents volatile up to 100° C. and at a reduced pressure of 2 mmHg, 204 g of a slightly yellow, opaque material were obtained which contains the following structural elements

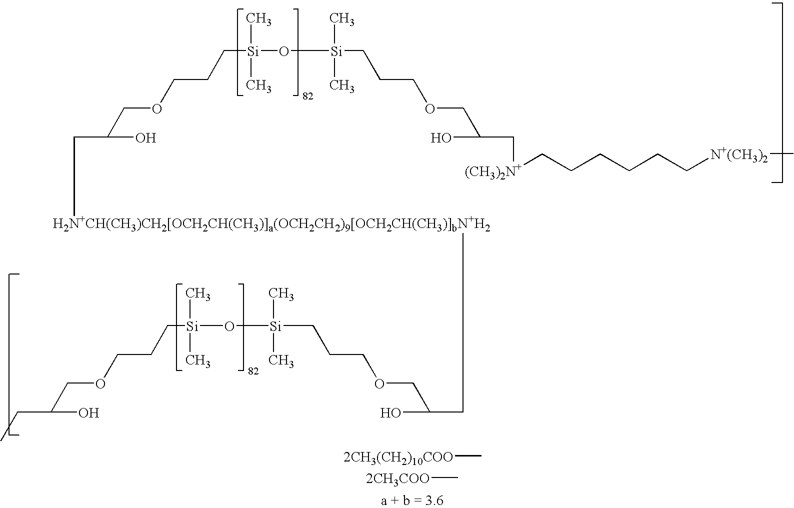

Starting from this silicone material, three microemulsion concentrates of the following composition were prepared:

| Formulation 1 (F1) | Formulation 2 (F2) | Formulation 3 (F3) |
|---|---|---|
| 430 g SQ | 430 g SQ | 430 g SQ |
| 258 g Renex ® 36 | 125 g Renex ® 36 | 125 g Renex ® 36 |
| 44.5 g Renex ® 30 | 44.5 g Renex ® 30 | 44.5 g Renex ® 30 |
| 10 g acetic acid | 10 g acetic acid | 10 g acetic acid |
| 7.5 g sodium acetate | 7.5 g sodium acetate | 7.5 g sodium acetate |
| 245 g dist. water | 245 g dist. water | 245 g dist. water |
| | 79.5 g 2-Propanol | 79.5 g 2-Propanol |
| | 87.5 g Crodet S40 | 59 g Crodet ® S40 |

These three microemulsion concentrates (about 40% based on SQ) are diluted uniformly with water to 11% silicone quat content in each case. Of these 11% transparent microemulsions, in each case 6 g (absolute amount of silicone quat 0.66 g) are withdrawn, mixed intensively with 6000 ml of water and optionally additives and utilized for jet finishing under the following boundary conditions:

Jet type: Mathis Labor-Jumbo-Jet

Jet pump: Level 6 (highest possible shear)

Amount of water in the jet: 6000 ml

Finishing: 15 minutes at 40° C.

Drying: 80° C.

Textile: 300 g bleached and with optical brightener (e.g. Blankophor® BA treated cotton pullover).

The following table summarizes the results of the finishing experiments.

| | | | | Hand | | Foam height |
|---|---|---|---|---|---|---|
| | | | Silicone | after | Hydrophi- | in the jet |
| No. | Formul. | Additive | deposition* | drying** | licity*** | in cm |
| 1 | F1 | | high deposits, | ok | ok | 12-13 |
| | | | tacky | | | |
| 2 | F1 | 0.39 g Renex ® 36 | high deposits, | ok | ok | 12-13 |
| | | 0.06 g Renex ®30 | tacky | | | |
| 3 | F1 | 0.5 g Al₂(SO₄)₃.16H₂O | no deposits, | ok | ok | 5-6 |
| | | | few defects | | | |
| 4 | F1 | 0.05 g Al₂(SO₄)₃.16H₂O | no deposits, | ok | ok | 5-6 |
| | | 3 g MgCl₂x6H₂O | few defects | | | |
| 5 | F2 | | no deposits, | ok | ok | 6-7 |
| | | | no defects | | | |
| 6 | F3 | 0.02 g Crodet ® S40 | no deposits, | ok | ok | 6-7 |
| | | | no defects | | | |
| 7 | F1 | 0.18 g Crodet ® S40 | no deposits, | ok | ok | 6-7 |
| | | | no defects | | | |

*Deposits on glass and steel parts of the jet
**Having a silicone-like softness with volume increase
***Drop absorption time ≦3 seconds
Renex ® 36, trade name of ICI surfactants; tridecyl alcohol-(EO)₁₂—OH
Renex ® 30, trade name of ICI surfactants; tridecyl alcohol-(EO)₆—OH
Crodet ® S40, trade name of Croda GmbH; stearic acid-(EO)₄₀—OH

Experiment 1 describes the unacceptable result of a noninventive prior art experiment. Doubling of the amount of both Renex surfactants does not lead to prevention of deposits (Experiment 2, noninventive).

Experiments 3 and 4 demonstrate that an inventive addition of salts of polyvalent cations can reliably prevent deposits. Aluminum salts are more effective than magnesium compounds.

Experiment 5 shows that an inventive incorporation of hydrophilic interface-active compounds directly into the formulation reliably prevents deposits. It is also true of a likewise inventive partial subsequent addition (Experiment 6) or inventive full addition (Experiment 7) of this hydrophilic interface-active compound.

What is claimed is:

1. A formulation comprising at least one quaternized aminoalkylsiloxane and at least one compound from the group of
a) the hydrophilic, nonionogenic, interface-active compounds,
b) the hydrophilic dispersants and
c) the salts of di- or trivalent metals with inorganic acids.

2. The formulation as claimed in claim 1, characterized in that the hydrophilic, nonionogenic, interface-active compounds (a) are compounds modified with ethylene/propylene oxide (EO/PO), optionally unsaturated and/or branched, from the group of the fatty alcohols, fatty acids, alcohols, acids, alkylaryl derivatives, fatty amines, glycerides and sorbitan esters, in each of which the number of EO/PO units is between 15 and 150, the ratio of PO units to EO units being equal to or lower than 0.25, and in which the number of ethylene oxide units (EO fraction) is greater than or equal to the number of carbon atoms in the non-EO fraction, or are alkylpolyglycosides, ethylene oxide/propylene oxide copolymers and polyethersiloxanes.

3. The formulation as claimed in at least one of claims 1 and 2, characterized in that the hydrophilic dispersants (b) are water-soluble polysaccharides from the group of the substituted celluloses.

4. The formulation as claimed in at least one of claims 1 to 3, characterized in that the salts (c) are those of the metals calcium, magnesium and aluminum with hydrochloric acid, sulfuric acid or phosphoric acid, and the salts may also be present in the form of their hydrates.

5. The formulation as claimed in at least one of claims 1 to 4, characterized in that compound (a) is a compound of the formulae (1) to (9) 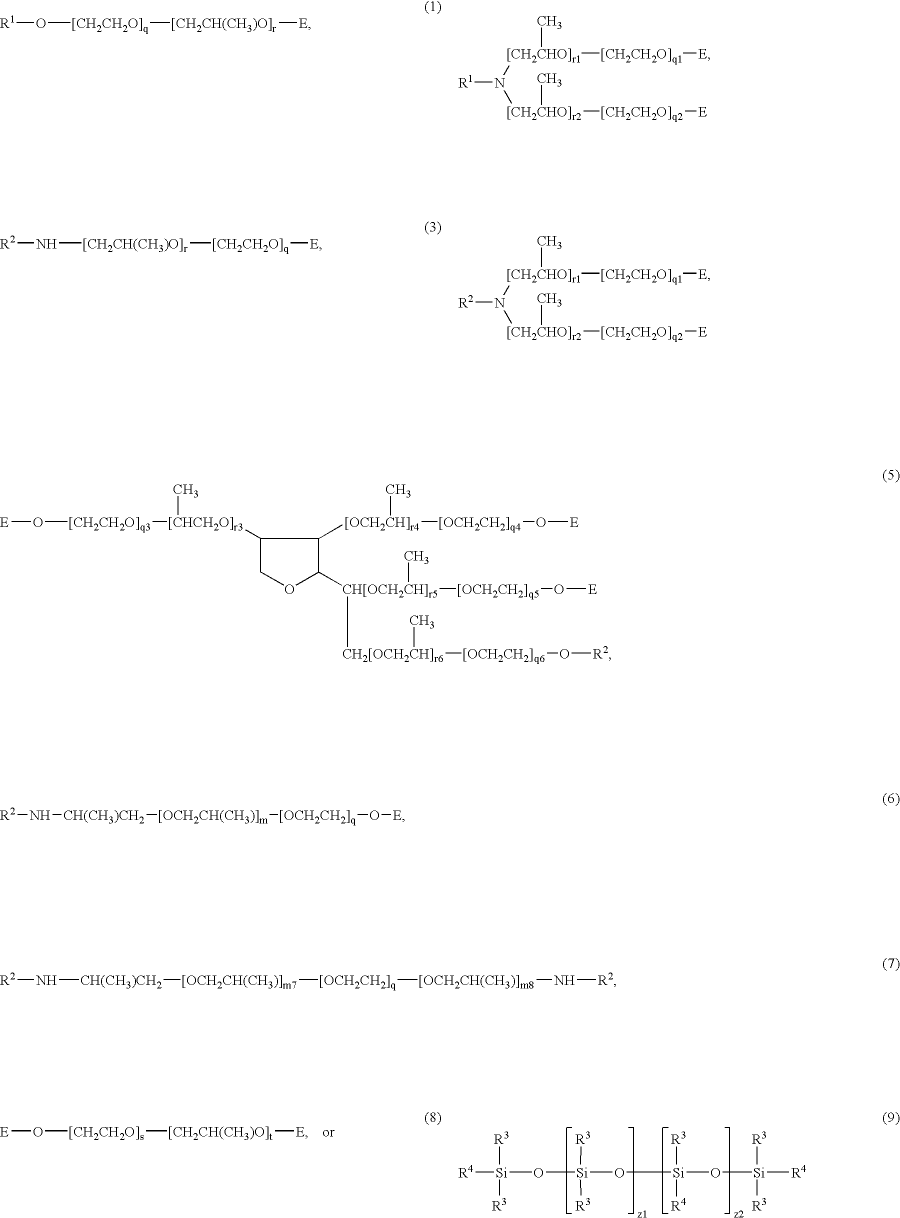
where
E is an R¹ radical, hydrogen, straight-chain or branched, saturated or mono- or polyunsaturated C₁-C₁₈-alkyl which is optionally mono- or polysubstituted by —OH, C₁-C₄-alkoxy, C₁-C₄-alkoxycarbonyl or carbonyl, or is C₅-C₁₀-cycloalkyl which is optionally mono- or polysubstituted by C₁-C₄-alkyl, —OH, C₁-C₄-alkoxy, C₁-C₄-alkoxycarbonyl or carbonyl
R¹ is straight-chain or branched, saturated or unsaturated C₈-C₄₀-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₁₀-cycloalkyl whose alkyl chain is optionally singly or multiply by oxygen mono- or polysubstituted by C₁-C₄-alkyl, —OH, C₁-C₄-alkoxy, C₁-C₄-alkoxycarbonyl or carbonyl, amino, mono- or di-C₁-C₄-alkyl-amino,
R² is straight-chain or branched, saturated or mono- to polyunsaturated C₈-C₄₀-alkyl which is optionally mono- or polysubstituted by —OH, C₁-C₄-alkoxy, C₁-C₄-alkoxycarbonyl or carbonyl,
R³ is straight-chain or branched C₁-C₂₆-alkyl or C₆-C₁₀-aryl,
R⁴ is R³ or a radical of the formulae
—CH₂CH₂—O—[CH₂CH₂O]_{q}—[CH₂CH(CH₃)O]ᵣ-E,
—CH₂CH₂CH₂—O—[CH₂CH₂O]_{q}—[CH₂CH(CH₃)O]ᵣ-E
—CH₂CH₂CH₂—O—CH₂CHOHCH₂—O—[CH₂CH₂O]_{q}—[CH₂CH(CH₃)O]ᵣ-E
—Z—[CH₂CH₂O]_{q}—[CH₂CH(CH₃)O]ᵣ-E
where
Z is a straight-chain or branched alkyl or cycloalkyl radical which is in each case interrupted by —O— and/or —CO— and may optionally be substituted by at least one OH group,
or 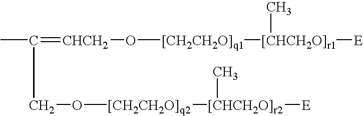
q is from 15 to 150,
q1 and q2 are each independently from 0 to 150
where the sum of q1+q2=q,
q3, q4, q5 and q6 are each independently from 0 to 150
where the sum of q3+q4+q5+q6=q,
r is from 0 to 50,
r1 and r2 are each independently from 0 to 50
where the sum of r1+r2=r,
r3, r4, r5 and r6 are each independently from 0 to 50
where the sum of r3+r4+r5+r6=r, and
the ratio of r:q≦0.25;
m is from 1 to 50,
m7 and m8 are each independently from 1 to 50
where 2≦m7+m8 and the sum of m7+m8=m+1, and
the ratio of q:m≧4,
s is from 5 to 150,
t is from 5 to 150
where 0.05≦s:t≦20,
0≦z1≦2000,
0<z2≦2000,
at least one R4≠R3, and
0.01≦Σ alkyl radicals R³:Σ q+r≦1.

6. The formulation as claimed in at least one of claims 1 to 5, characterized in that compound (a) is a compound of the formulae (1) to (9) as claimed in claim 5, where
E is hydrogen, straight-chain or branched, saturated or mono- or polyunsaturated C₁-C₄-alkyl which is optionally mono- to disubstituted by —OH, C₁-C₄-alkoxy, C₁-C₄-alkoxycarbonyl or carbonyl, or is C₅-C₆ -cycloalkyl which is in each case optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₁₀-C₃₆-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₆-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, Cₗ-C₄-alkoxycarbonyl or carbonyl, amino, mono- or di-C₁-C₄-alkylamino,
R² is straight-chain or branched, saturated or mono- to polyunsaturated C₁₀-C₃₆-alkyl which is optionally mono- or polysubstituted by —OH, C₁-C₄-alkoxy, C₁-C₄-alkoxycarbonyl or carbonyl,
R³ is straight-chain or branched C₁-C₁₈-alkyl or C₆-C₁₀-aryl,
R⁴ is an R³ radical or is a radical of the formulae
—CH₂CH₂—O—[CH₂CH₂O]_{q}—[CH₂CH(CH₃)O]ᵣ-E,
or
—CH₂CH₂CH₂—O—[CH₂CH₂O]_{q}—[CH₂CH(CH₃)O]ᵣE,
q1 and q2 are each independently from 20 to 100
where the sum of q1+q2=q,
q3, q4, q5 and q6 are each independently from 20 to 100
where the sum of q3+q4+q5+q6=q,
r is from 0 to 20,
r1 and r2 are each independently from 0 to 20
where the sum of r1+r2=r,
r3, r4, r5 and r6 are each independently from 0 to 20
where the sum of r3+r4+r5+r6=r, and
the ratio of r:q≦0.25,
m is from 1 to 7,
m7 and m8 are each independently from 1 to 7
where 2≦m7+m8 and the sum of m7+m8=m, and
the ratio of q:m≧4,
s is from 5 to 100,
t is from 5 to 100
where 0.05≦s:t≦20,
0≦z1≦2000,
0≦z2≦2000,
at least one R4≠R3, and
0.01≦Σ alkyl radicals R³:Σ q+r≦0.5.

7. The formulation as claimed in at least one of claims 1 to 4, characterized in that compound (a) is a compound of the formulae (1′) to (9′) 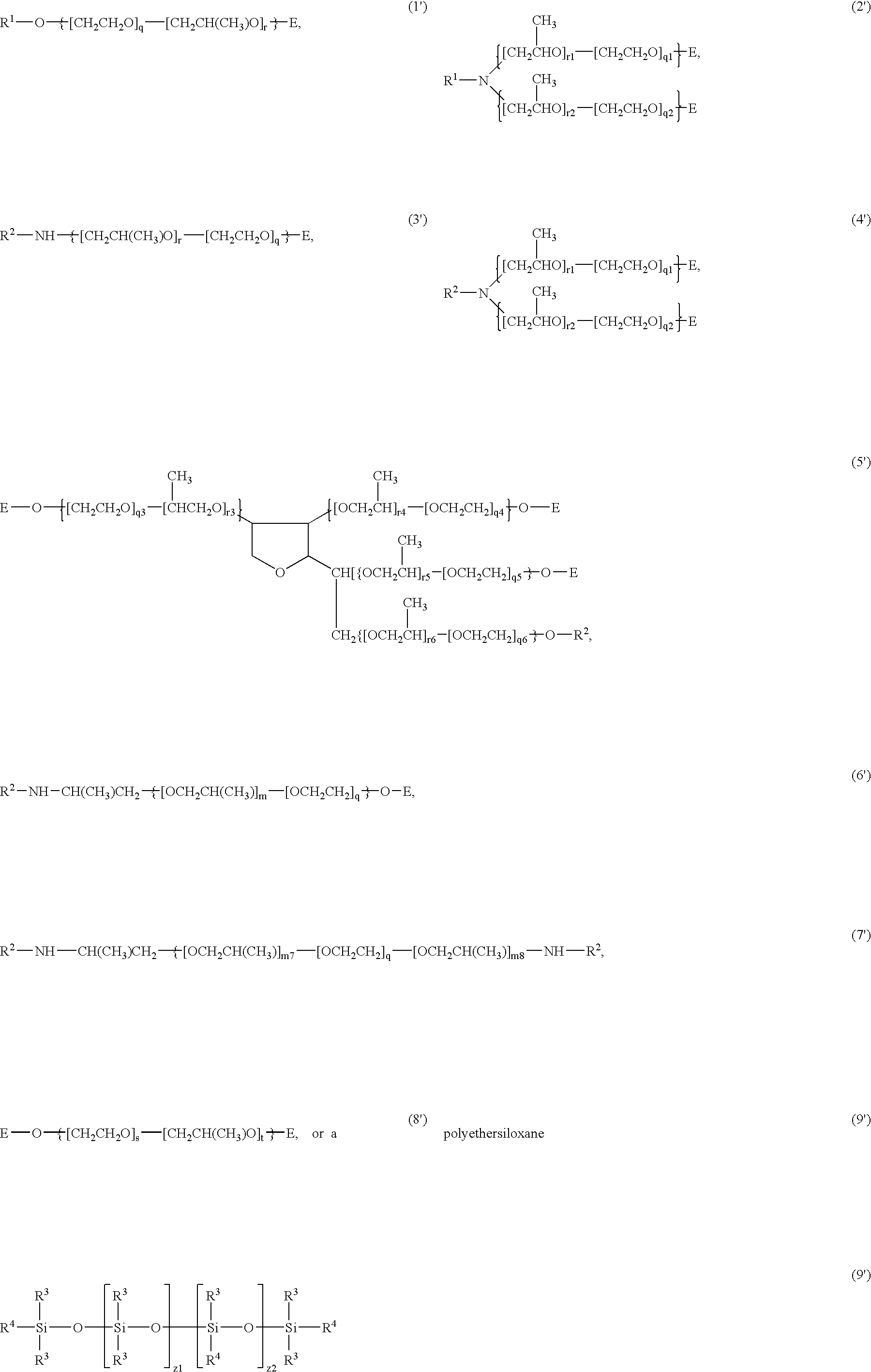
where
the brackets “{” and “}” shown in formulae (1′)-(8′) ethylene oxide or propylene oxide units may either be arranged blockwise as shown or else be in any random distribution,
E is an R¹ radical, hydrogen, straight-chain or branched, saturated or mono- or polyunsaturated C₁-C₁₈-alkyl which is optionally mono- or polysubstituted by —OH, C₁-C₄-alkoxy, C₁-C₄-alkoxycarbonyl or carbonyl, or is C₅-C₁₀-cycloalkyl which is optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₈-C₄₀-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₁₀-cycloalkyl whose alkyl chain is optionally interrupted singly or multiply by oxygen and/or nitrogen atoms and which is optionally mono- or polysubstituted by C₁-C₄-alkyl, —OH, C₁-C₄-alkoxy, Cₗ-C₄-alkoxycarbonyl or carbonyl, amino, mono- or di-C₁-C₄-alkylamino, or is C₆-C₁₀-aryl which is optionally substituted, especially by C₃-C₁₅-alkoxycarbonyl alkyl,
R² is straight-chain or branched, saturated or mono- to polyunsaturated C₈-C₄₀-alkyl which is optionally mono- or polysubstituted by —OH, C₁-C₄-alkoxy, C₁-C₄-alkoxycarbonyl or carbonyl,
R³ is straight-chain or branched C₁-C₂₆-alkyl or C₆-C₁₀-aryl,
R⁴ is R³ or is a radical of the formulae 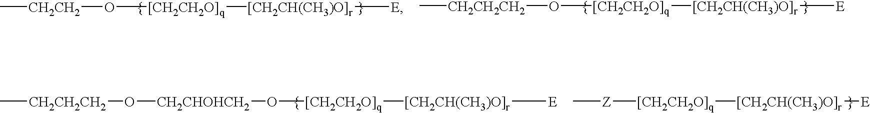
where
Z is a straight-chain or branched alkyl or cycloalkyl radical which is in each case interrupted by —O— and /or —CO— and may optionally be substituted by at least one OH group
or 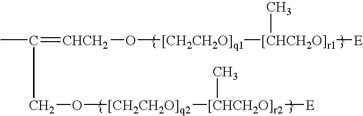
q is from 15 to 150,
q1 and q2 are each independently from 0 to 150
where the sum of q1+q2=q,
q3, q4, q5 and q6 are each independently from 0 to 150
where the sum of q3+q4+q5+q6=q,
r is from 0 to 50,
r1 and r2 are each independently from 0 to 50
where the sum of r1+r2=r,
r3, r4, r5 and r6 are each independently from 0 to 50
where the sum of r3+r4+r5+r6=r, and
the ratio of r:q≦0.25,
m is from 1 to 50,
m7 and m8 are each independently from 1 to 50
where 2≦m7+m8, and
the ratio of q:m≧4,
s is from 5 to 150, preferably 15-150,
t is from 5 to 150, preferably from 5 to 150 and in particular from 5 to 20,
0≦z1≦2000,
0≦z2≦2000,
at least one R4≠R3, and
for formula (9′):
0.01≦Σ alkyl radicals R³:Σ q+r≦1.

8. The formulation as claimed in at least one of claims 1 to 4 or 7, characterized in that compound (a) is a compound of the formulae (1′) to (9′) as claimed in claim 7, where
E is hydrogen, straight-chain or branched, saturated or mono- or polyunsaturated C₁-C₄-alkyl which is optionally mono- to disubstituted by —OH, C₁-C₄-alkoxy, C₁-C₄-alkoxycarbonyl or carbonyl, or is C₅-C₆ -cycloalkyl which is in each case optionally mono- or polysubstituted by C₁-C₄-alkyl, —OH, C₁-C₄-alkoxy, C₁-C₄-alkoxycarbonyl or carbonyl,
R¹ is straight-chain or branched, saturated or unsaturated C₁₀-C₃₆-alkyl whose alkyl chain is optionally interrupted singly or multiply by oxygen and/or nitrogen atoms and which is optionally mono- or polysubstituted by —OH, C₁-C₄-alkoxy, C₁-C₄-alkoxycarbonyl or carbonyl, amino, mono- or di-C₁-C₄-alkylamino, or is C₅-C₆-cycloalkyl whose alkyl chain is optionally interrupted singly or multiply by oxygen and/or nitrogen atoms and which is optionally singly or multiply by C₁-C₄-alkyl, —OH, C₁-C₄-alkoxy, C₁-C₄-alkoxycarbonyl, or is C₆-C₁₀-aryl which is optionally substituted, especially by C₃-C₁₅-alkyl,
R² is straight-chain or branched, saturated or mono- to polyunsaturated C₁₀-C₃₆-alkyl which is optionally mono- or polysubstituted by —OH, C₁-C₄-alkoxy, C₁-C₄-alkoxycarbonyl or carbonyl,
R³ is straight-chain or branched C₁-C₁₈-alkyl or C₆-C₁₀-aryl,
R⁴ is an R³ radical or is a radical of the formulae 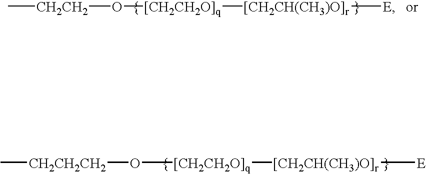
q is from 20 to 100,
q1 and q2 are each independently from 20 to 100
where the sum of q1+q2=q,
q3, q4, q5 and q6 are each independently from 20 to 100
where the sum of q3+q4+q5+q6=q,
r1 and r2 are each independently from 0 to 20
where the sum of r1+r2=r,
r3, r4, r5 and r6 are each independently from 0 to 20
where the sum of r3+r4+r5+r6=r, and
the ratio of r:q≦0.25,
m is from 1 to 7,
m7 and m8 are each independently from 1 to 7
where 2≦m7+m8, and
the ratio of q:m≧4,
s is from 5 to 100, preferably from 15 to 100
t is from 5 to 100, preferably from 5 to 20
where t:s≦0.25,
0≦z1≦2000,
0≦z2≦2000,
at least one R4≠R3,
and
for the formula (9′):
0.01≦Σ alkyl radicals R³:Σ q≦0.5.

9. The formulation as claimed in at least one of claims 1 to 6, characterized in that compound (a) corresponds to the formulae (1) to (9) as claimed in claim 5, where
E is H, CH₃—, CH₃CH₂—, CH₃CH₂CH₂—, (CH₃)₂CH—, CH₃CH₂CH₂CH₂— or CH₃C(O)—,
R¹ is a radical of the formulae 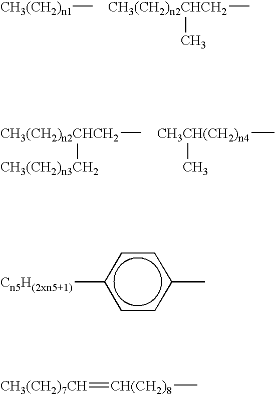
where
n1=from 9 to 23,
n2=from 3 to 23,
n3=from 0 to 18,
n4=from 7 to 23,
n5=from 3 to to 15,
R² is a radical of the formulae 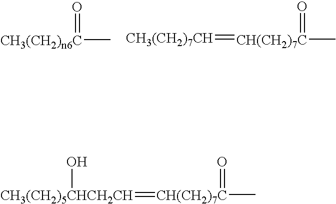
where
n6=8 to to 28,
R³ is C₁-C₁₈-alkyl or C₆-C₁₀-aryl,
R⁴ is an R³ radical or is a radical of the formulae
—CH₂CH₂—O—[CH₂CH₂O]_{q}—[CH₂CH(CH₃)O]ᵣ-E,
or
—CH₂CH₂CH₂—O—[CH₂CH₂O]_{q}—[CH₂CH(CH₃)O]ᵣ-E
q is from 25 to 60,
q1 and q2 are each independently from 25 to 60
where the sum of q1+q2=q,
q3, q4, q5 and q6 are each independently from 25 to 60
where the sum of q3+q4+q5+q6=q,
r is from 0 to 10,
r1 and r2 are each independently from 0 to 10
where the sum of r1+r2=r,
r3, r4, r5 and r6 are each independently from 0 to 10,
the ratio of r:q≦0.25, and
for the formula (9):
0.01≦Σ alkyl radicals R³:Σ q+r≦0.1.

10. The formulation as claimed in at least one of claims 1 to 4 and 7 to 8, characterized in that compound (a) corresponds to the formulae (1′) to (9′) as claimed in claim 7, where
E is H, CH₃—, CH₃CH₂—, CH₃CH₂CH₂—, (CH₃)₂CH—, CH₃CH₂CH₂CH₂— or CH₃C(O)—
R¹ is a radical of the formulae 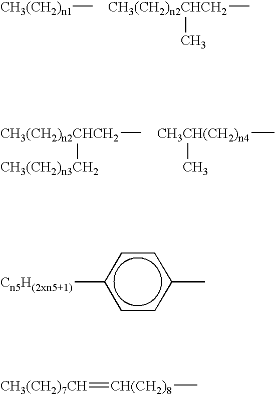
n1=from 9 to 23,
n2=from 3 to 23, preferably from 6 to 23
n3=from 0 to 18, where, preferably, n2+n3≦31,
n4=from 7 to 23,
n5=from 3 to to 15,
R² is a radical of the formulae 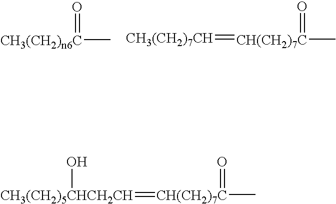
where
n6=8 to to 28,
R³ is C₁-C₁₈-alkyl or C₆-C₁₀-aryl,
R⁴ is an R³ radical or is a radical of the formulae 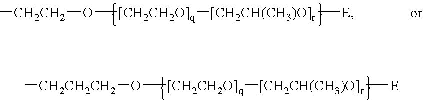
q is from 25 to 60,
q1 and q2 are each independently from 25 to 60
where the sum of q1+q2=q,
q3, q4, q5 and q6 are each independently from 25 to 60
where the sum of q3+q4+q5+q6=q,
r is from 0 to 10,
r1 and r2 are each independently from 0 to 10
where the sum of r1+r2=r,
r3, r4, r5 and r6 are each independently from 0 to 10,
where the sum of r3+r4+r5+r6=r, and
for the formula (9′):
0.01≦Σ alkyl radicals R³:Σ q≦0.1.

11. The formulation as claimed in at least one of claims 1 to 10, characterized in that the compounds (b) are carboxymethylcellulose, hydroxyethylcellulose, methylhydroxypropylcellulose or a compound of the formula 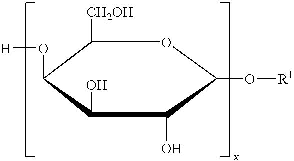
where
x is from 1.5 to 20, preferably from 1.5 to 10.

12. The formulation as claimed in at least one of claims 1 to 11, characterized in that the quaternized aminoalkylsiloxanes are linear or cyclic polysiloxane polymers having repeating structural units of the formulae (10) and (11) 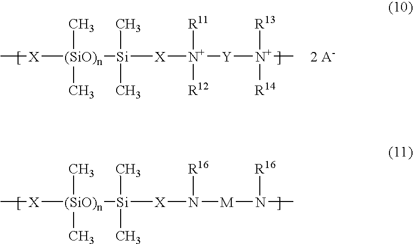
where
X is a divalent hydrocarbon radical having at least 4 carbon atoms which may have a hydroxyl group, preferably has a hydroxyl group, and which may be interrupted by one oxygen atom, and the X groups in the repeating units may the same or different,
Y is a divalent hydrocarbon radical having at least 2 carbon atoms which has a hydroxyl group and which may be interrupted by one or more oxygen or nitrogen atoms,
R¹¹, R¹², R¹³ and R¹⁴ are the same or different and are each alkyl radicals having from 1 to 4 carbon atoms or benzyl radicals, or the R¹ and R³ or R² and R⁴ radicals may in each case be constituents of a bridging alkylene radical,
R¹⁶ is H or an alkyl radical having from 1 to 20 carbon atoms which may be oxygen-substituted,
M is the structure —B—O-(EOx)ᵥ(POx)_{w}-B—, where
EOx is an ethylene oxide unit and POx is a propylene oxide unit,
B is straight-chain or branched C₂-C₆-alkylene,
v is from 0 to 200,
w is from 0 to 200,
v+w≧1,
n is from 2 to 1000 where the n in the repeating units may be the same or different,
A⁻ is an inorganic or organic anion.

13. The formulation as claimed in at least one of claims 1 to 12, comprising at least one quaternized aminoallcylsiloxane and at least one compound from the group of the hydrophilic, nonionogenic, interface-active compounds (a).

14. The formulation as claimed in at least one of claims 1 to 13, characterized in that the compound (a) present is the ester of stearic acid and 40 mol of EO.

15. The formulation as claimed in at least one of claims 1 to 14, characterized in that, as a further component, at least one compound (f) from the group of the interface-active compounds and emulsifiers is present.

16. The formulation as claimed in claim 15, characterized in that, as interface-active substances f) the ether of tridecyl alcohol with 12 mol of EO and the ether of tridecyl alcohol with 6 mol of EO are present.

17. The formulation as claimed in at least one of claims 1 to 16, characterized in that the amounts of hydrophilic, nonionogenic, interface-active compounds (a) and/or hydrophilic dispersants (b) and/or salts (c) to the amounts of quaternized aminoalkylsiloxane compounds are in a ratio Ω of Ω=0.05 to 10.

18. The use of the formulation as claimed in at least one of claims 1 to 17 as a textile softener in the finishing of textile structures by the continuous or exhaust process.

19. The use as claimed in claim 18 for the finishing of textile structures made of cotton, keratin fibers, preferably wool, silk, synthetic fibers or mixtures of the aforementioned types.

20. The use as claimed in claim 18 for the finishing of textile structures made of mixtures of cotton with polyester, polyamide, polyacrylonitrile, wool or silk.

21. The use as claimed in claim 18 for the finishing of textile structures made of polyester, polyamide, polypropylene or mixtures thereof.

22. The use as claimed in at least one of claims 19 to 20, characterized in that textile structures made of cotton or of mixtures of cotton with polyester, polyamide, polyacrylonitrile, wool or silk, said textile structures having been pretreated with anionic whiteners, are finished in a jet dyeing apparatus.

23. A process for preparing the formulations as claimed in at least one of claims 1 to 17, characterized in that at least one quaternized aminoalkylsiloxane is mixed with at least one compound from the group of
(a) the hydrophilic, nonionogenic, interface-active compounds,
(b) the hydrophilic dispersants and
the salts of di- and trivalent metals with inorganic acids and optionally further assistants and/or additives in the temperature range of preferably from 20 to 90° C.
